(19) United States
(12) Patent Application Publication
(10) Pub. No.: US 2026/0145626 A1
(43) Pub. Date: May 28, 2026

(54) SYSTEMS AND METHODS FOR MANAGEMENT OF VEHICLE ON-BOARD POWER SYSTEM ENERGY USAGE

(71) Applicant: Ford Global Technologies, LLC, Dearborn, MI (US)

(72) Inventors: Keith Weston, Canton, MI (US); Stuart C. Salter, White Lake, MI (US); Brendan Diamond, Naples, FL (US); Todd Ansbacher, Westland, MI (US); Vyas Darshan Shenoy, Canton, MI (US)

(73) Assignee: Ford Global Technologies, LLC, Dearborn, MI (US)

(21) Appl. No.: 18/957,023

(22) Filed: Nov. 22, 2024

(51) Int. Cl. B60R 16/033; H02J 4/00

(52) U.S. Cl. CPC B60R 16/033; H02J 4/00; H02J 2105/30

(57) ABSTRACT

A vehicle having a vehicle power system is disclosed. The vehicle may include a battery and the vehicle power system configured to transfer power from the battery to an external accessory connected to the vehicle power system. The vehicle may further include a vehicle sensor configured to detect an actual energy usage of the vehicle power system. The vehicle may further include a processor configured to determine a type of external accessory connected to the vehicle power system and determine an expected energy usage associated with the external accessory based on the type. The processor may determine the actual energy usage of the vehicle power system or the external accessory based on inputs obtained from the vehicle sensor or an external accessory sensor. The processor may compare the actual energy usage with the expected energy usage, and perform an action based on the comparison.

### FIELD

The present disclosure relates to a vehicle on-board power system and more particularly to systems and methods for management of energy usage of the vehicle on-board power system.

### BACKGROUND

Modern vehicles have external power systems (or on-board power) to power auxiliary accessories, such as compressors, saws, electronic devices, etc. Existing outlets associated with a vehicle's external power system have circuit breakers that stop the flow of current from the external power system if the auxiliary accessory draws power/current greater than a threshold. The auxiliary accessory may draw more power due to increased usage or prolonged usage of the auxiliary accessory, due to certain environmental conditions in which the auxiliary accessory may be operating, or when the auxiliary accessory is in a suboptimal condition.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example system to manage energy usage of a vehicle power system in accordance with the present disclosure.

FIG. 3 depicts exemplary remedial actions performed by a vehicle in accordance with the present disclosure.

FIG. 4 depicts a flow diagram of an example method to manage energy usage of a vehicle power system in accordance with the present disclosure.

### DETAILED DESCRIPTION

### Overview

The present disclosure describes a system and method to manage the energy usage of a vehicle power system that may be part of a vehicle. The vehicle power system may transfer power from a vehicle battery to an external accessory (e.g., a power tool, a lighting device, a motor, a saw, and/or the like). The vehicle power system may include electrical outlets (or any type of hardwired connection) that may enable the supply of power from the battery to the external accessory or a plurality of external accessories at the same time. The electrical outlets may be disposed in proximity to a vehicle cargo bed or a vehicle tailgate. In some aspects, the system may control or manage the vehicle power system usage/operation to enhance the user experience of using the vehicle power system and manage the external accessory usage to optimize the external accessory durability.

In some aspects, to optimize the vehicle power system usage, the system may first determine or identify a type of an external accessory that may be connected to the vehicle's power outlet. In an exemplary aspect, the system may identify the external accessory type by using images captured from vehicle cameras, user inputs, vehicle-to-external accessory communication, and/or the like. In further aspects, the external accessory may include a Radio Frequency Identification (RFID) tag that may include information associated with the external accessory type, the system may use RFID readers (that may be installed in the vehicle) to read the information from the RFID tag and determine the external accessory type. In some aspects, the system may use machine learning and image recognition techniques to identify the external accessory type.

Responsive to determining the external accessory type, the system may determine an expected energy usage of the external accessory when the external accessory connects to the vehicle power system. The system may determine the expected energy usage based on the external accessory type. For example, the system may determine an external accessory energy consumption profile that includes characterization of energy consumption pattern over time, which may indicate the expected power usage (e.g., how much energy the external accessory may draw from the vehicle power system). In addition, the system may determine the external accessory power/current rating based on the external accessory type, which may indicate the expected power usage. In some aspects, the system may obtain a pre-stored mapping of different external accessory types and corresponding expected energy usage information. The system may determine the expected energy usage based on the pre-stored mapping.

The system may further determine an actual energy usage associated with the vehicle power system or the external accessory when the external accessory may be connected to the vehicle power system. The actual energy usage may be, for example, an amount of energy (or current/power) drawn, a time duration for which the energy is drawn, and/or a rate at which the energy is drawn, etc. In some aspects, the system may obtain inputs from a vehicle sensor or an external accessory sensor that detects the actual energy usage and determine the actual energy usage based on the obtained inputs.

Responsive to determining the expected energy usage and the actual energy usage as described above, the system may correlate or compare the expected energy usage with the actual energy usage, and perform one or more actions (e.g., remedial actions) based on the comparison. As an example, the system may determine whether the current output from the vehicle power system is greater than the external accessory current rating or whether the power output from the vehicle power system is greater than the external accessory power rating. The system may perform a remedial action when the vehicle power system output current/power is greater than the external accessory current/power rating. As another example, the system may perform a remedial action when the system determines that the power/current consumption of the external accessory is less than or greater than the expected energy usage.

In some aspects, the remedial action may include outputting a notification for the user via a vehicle speaker system (e.g., an exterior sound exciter), a user device, an infotainment system (or a vehicle human-machine interface), and/or the like. The notification may indicate the current consumption associated with the external accessory. In some aspects, the notification may further indicate that the actual energy usage may be greater or less than the expected energy usage. In further aspects, the notification may indicate an instruction/recommendation to turn-off the external accessory.

In some aspects, the system may determine different external accessories that may be connected to the vehicle power system at the same time, based on respective expected energy usage. Responsive to determining that an external accessory (e.g., an accessory “A”) should not be connected to the vehicle power system when another external accessory (e.g., an accessory “B”) is connected to the vehicle power system, the system may output a notification to the user.

In further aspects, the system may determine an optimal time to connect the external accessory to the vehicle power system (when the energy may be optimally transferred from the vehicle battery to the external accessory) based on weather/environmental conditions and may output a notification to the user indicating the optimal time to connect the external accessory to the vehicle power system.

In further aspects, the system may perform the remedial action by automatic controlling the vehicle power system. For instance, the system may de-rate the power/current when the actual energy usage is greater than the expected energy usage. Alternatively, the system may deactivate the vehicle power system when the actual energy usage is greater than the expected energy usage. In addition, the system may automatically control a vehicle parameter to increase the available power for the vehicle power system. For example, the system may turn-off a vehicle audio system, a vehicle climate control system, and/or the like, to increase the available power for the vehicle power system.

The present disclosure discloses a system and method that enhances user experience of using the vehicle power system. The system leverages machine learning and the sensor suite information to determine when external accessories/tools are consuming an amount of current that is different from the expected and react to that unexpected current draw by helping the user understand the best course of action. In addition, the system helps the user to manage external accessory usage to optimize external accessory durability and ensures that the best possible external accessory is being deployed and the efficiency of their usage is optimized.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

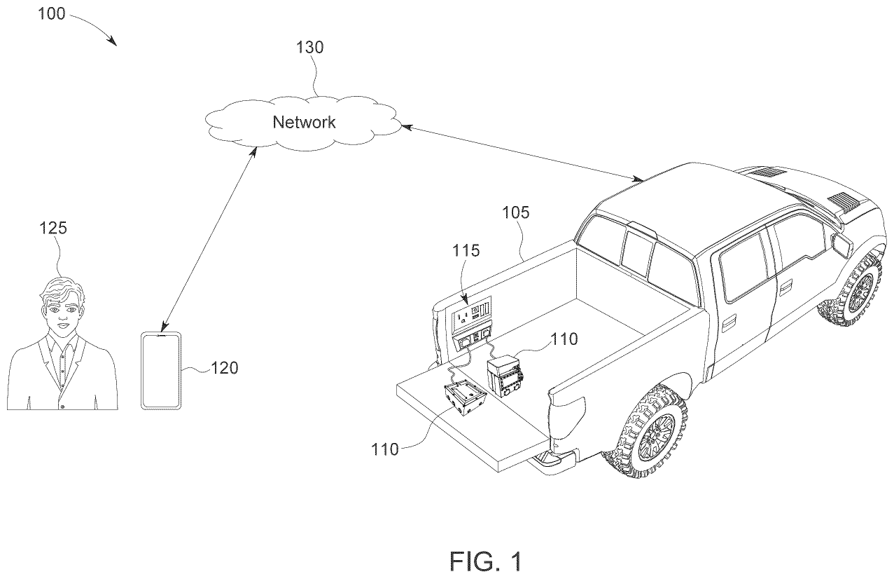

FIG. 1 depicts an example environment 100 in which techniques and structures for providing the systems and methods disclosed herein may be implemented. The environment 100 may include a vehicle 105 that may be a truck, a van, a truck trailer, and/or the like. The vehicle 105 may include any powertrain such as a gasoline engine, one or more electrically-actuated motor(s), a hybrid system, etc. Furthermore, the vehicle 105 may be a manually driven vehicle and/or be configured and/or programmed to operate in a fully autonomous (e.g., driverless) mode (e.g., Level-5 autonomy) or in one or more partial autonomy modes which may include driver assist technologies.

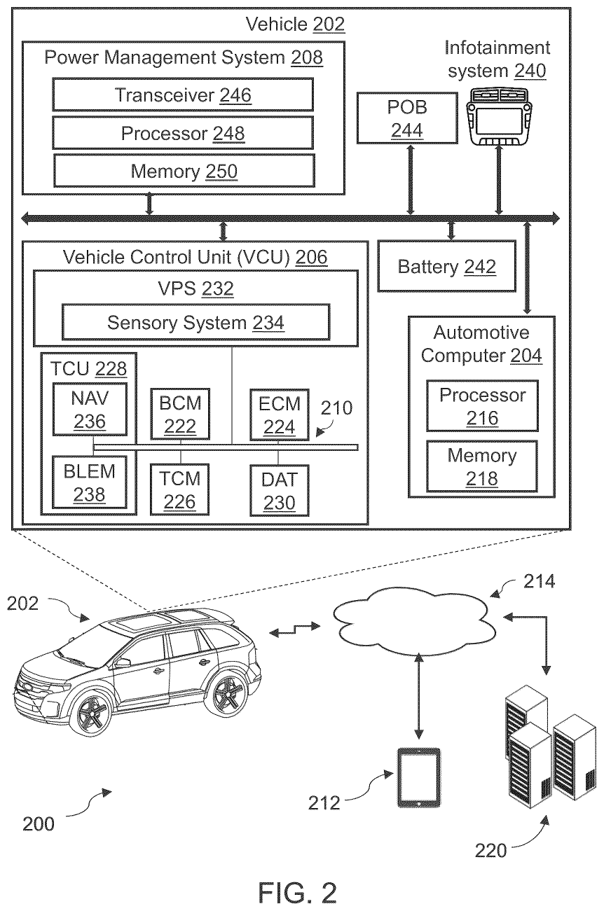

The vehicle 105 may include a vehicle power system (shown as power on-board (POB) 244 in FIG. 2) that may provide/supply power to an external accessory 110. In some aspects, the vehicle power system may transfer power from a vehicle's battery (shown as battery 242 in FIG. 2) to the external accessory 110. The battery may be disposed in the vehicle 105. The external accessory 110 may be, for example, a plasma cutter, a TiG welder, a chop saw, an air compressor, an angle grinder, a jackhammer, a projector, loudspeakers, lighting devices, cement mixers, a mini fridge, and/or the like. The vehicle power system may include one or more electrical outlets 115 or any type of hardwired connection, such as a fixed hardwired connection, between the vehicle power system and the external accessory 110. In some aspects, the outlets 115 may be disposed in proximity to a vehicle cargo bed or a vehicle tailgate, as depicted in FIG. 1. The outlets 115 may enable flow of electricity from the battery to the external accessory 110 when the external accessory 110 is connected to the outlet 115 via one or more cables.

The environment 100 may further include a user device 120 that may be associated with a user 125. The user 125 may be associated with the vehicle 105, and may be, for example, a vehicle manager, a fleet manager, or a vehicle owner. The user device 120 may include a mobile device, a tablet, a laptop, a smart watch, or any other device with communication capabilities. The vehicle 105 and the user device 120 may communicatively couple with each other via one or more networks 130.

The network(s) 130 illustrates an example communication infrastructure in which the connected devices discussed in various embodiments of this disclosure may communicate. The network(s) 130 may be and/or include the Internet, a private network, public network or other configuration that operates using any one or more known communication protocols such as transmission control protocol/Internet protocol (TCP/IP), Bluetooth®, Bluetooth Low Energy (BLE), Wi-Fi based on the Institute of Electrical and Electronics Engineers (IEEE) standard 802.11, Ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

In some aspects, the vehicle 105 may further include a vehicle power management system (shown as power management system 208 in FIG. 2) configured to control the vehicle power system operation to optimally supply power to the external accessory 110 and/or manage the vehicle power system energy usage. In some aspects, to efficiently control the vehicle power system operation, the vehicle power management system (“system”) may first determine or identify a type of the external accessory 110 (hereinafter referred to as “external accessory type”) that may be attached to the vehicle power system. For instance, the system may identify whether the vehicle power system is attached/connected to a chop saw, an air compressor, an angle grinder, a jackhammer, a projector, loudspeakers, etc., and/or identify its size, version, and/or the like (collectively this information may constitute the external accessory type). The system may identify the external accessory type based on inputs obtained from a vehicle sensor suite (e.g., a vehicle camera), user inputs, a Radio Frequency Identification (RFID) reader, and/or the like.

Responsive to identifying the external accessory type, the system may determine an expected energy usage associated with the external accessory 110 based on the external accessory type. For instance, when the system determines that the vehicle power system is connected to a chop saw, the system may determine an expected energy usage of the chop saw. In some aspects, the system may determine an expected current/power that the external accessory 110 may draw from the vehicle power system or determine current/power rating associated with the external accessory 110 to determine the expected energy usage.

In some aspects, to determine the expected energy usage, the system may first obtain a pre-stored mapping of different external accessory types and corresponding expected energy usage information. The system may then determine the expected energy usage based on the pre-stored mapping (that may be pre-stored in a memory, such as memory 250 shown in FIG. 2). For instance, the system may obtain a first mapping of a plurality of types of external accessories (including the external accessory 110) and corresponding power ratings or current ratings and determine the expected energy usage based on the first mapping. In another instance, the system may obtain a second mapping of a plurality of types of external accessories and corresponding energy consumption profile and determine the expected energy usage based on the second mapping. The energy consumption profile may be a characterization of an expected energy consumption pattern over time.

The system may additionally determine an actual energy usage associated with the vehicle power system (or the actual energy that the vehicle power system may be providing/transferring) when the external accessory 110 may be connected to the vehicle power system. For example, the system may determine an actual or real-time current/power that the external accessory 110 may be drawing from the vehicle power system over a predetermined time duration. In some aspects, the system may determine the actual energy usage based on inputs obtained from a vehicle sensor that detects the actual energy usage associated with the vehicle power system in real-time. In some aspects, the system may additionally or alternatively determine an actual energy usage associated with the external accessory 110 when the external accessory 110 may be connected to the vehicle power system. For instance, the system may determine the actual or real-time current/power that the external accessory 110 may be drawing from the vehicle power system over a predetermined time duration. In some aspects, the system may determine the actual energy usage based on inputs obtained from an external accessory sensor associated with the external accessory 110, which detects the actual energy usage of the external accessory 110.

Responsive to determining the actual energy usage (e.g., the actual energy usage of the vehicle power system or the external accessory 110) and the expected energy usage, the system may compare the actual energy usage with the expected energy usage and perform one or more actions (e.g., remedial actions) based on the comparison. For instance, the system may determine whether the current output from the vehicle power system is greater than the external accessory current rating or if the power output from the vehicle power system is greater than the external accessory power rating. When the system determines that the current/power output from the vehicle power system is greater than the current/power rating associated with the external accessory 110, the system may transmit a notification to the user device 120 indicating that the external accessory 110 may be drawing more current/power than its rating. As another example, responsive to the determination described above, the system may automatically adjust the vehicle power system operation. For instance, the system may automatically de-rate the current/power supply from the vehicle power system to the external accessory 110, when the system determines that the external accessory 110 may be drawing more current/power than its rating. In this manner, the system efficiently controls the vehicle power system operation and optimizes the vehicle power system energy usage.

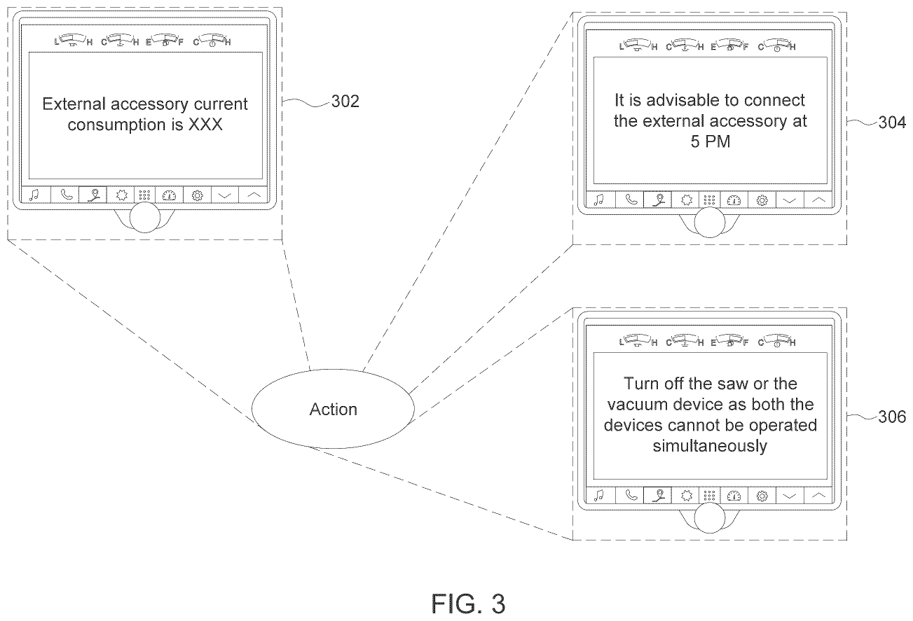

Further vehicle 105 and system details are described below in conjunction with FIGS. 2-3.

The vehicle 105 and the system implement and/or perform operations, as described here in the present disclosure, in accordance with the owner manual and safety guidelines. In addition, any action taken by the vehicle operator/fleet manager based on the notifications provided by the vehicle 105 should comply with all the rules specific to the location and operation of the vehicle 105 (e.g., Federal, state, country, city, etc.). The notifications, as provided by the vehicle 105, should be treated as suggestions and only followed according to any rules specific to the location and operation of the vehicle 105.

FIG. 2 depicts a block diagram of an example system 200 to manage energy usage of a vehicle power system in accordance with the present disclosure. While describing FIG. 2, references may be made to FIG. 3.

The system 200 may include a vehicle 202, which may be the same as the vehicle 105. The vehicle 202 may include an automotive computer 204, a Vehicle Control Unit (VCU) 206, and a power management system 208 (same as the vehicle power management system described above in conjunction with FIG. 1). The VCU 206 may include a plurality of Electronic Control Units (ECUs) 210 disposed in communication with the automotive computer 204.

The system 200 may further include a user device 212 that may connect with the automotive computer 204 and/or the power management system 208 by using wired and/or wireless communication protocols and transceivers. In some aspects, the user device 212 may be the same as the user device 120. The user device 212 may communicatively couple with the vehicle 202 via one or more network(s) 214. The network 214 may be the same as the network 130.

In some aspects, the automotive computer 204 and/or the power management system 208 may be installed anywhere in the vehicle 202, in accordance with the disclosure. Further, the automotive computer 204 may operate as a functional part of the power management system 208. The automotive computer 204 may be or include an electronic vehicle controller, having one or more processor(s) 216 and a memory 218. Moreover, the power management system 208 may be separate from the automotive computer 204 (as shown in FIG. 2) or may be integrated as part of the automotive computer 204.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a vehicle power management program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the automotive computer 204 and/or the power management system 208 may be disposed in communication with one or more server(s) 220 and the user device 212 via the network 214. In some aspects, the server(s) 220 may be part of a cloud-based computing infrastructure and may be associated with and/or include a Telematics Service Delivery Network (SDN) that provides digital data services to the vehicle 202 and other vehicles (not shown in FIG. 2) that may be part of a vehicle fleet. In further aspects, the server 220 may store real-time weather information, and may transmit this information to the vehicle 202 at a predefined frequency or when the vehicle 202 transmits a request to the server 220 to obtain such information. In addition, the server 220 may store details associated with power consumption rates and/or capacities (or expected power consumption rates) associated with different accessories (or different types of accessories) that may be connected with the vehicle power system to draw power. For instance, the server 220 may store a first mapping of a plurality of types of external accessories (including the external accessory 110) and corresponding power ratings or current ratings. In addition, the server 220 may store a second mapping of a plurality of types of external accessories and corresponding energy consumption profiles. The energy consumption profile may be a characterization of an expected energy consumption pattern over time. The server 220 may transmit the first and second mappings described above to the vehicle 202 at a predefined frequency, or when the vehicle 202 transmits a request to the server 220 to obtain such details.

In accordance with some aspects, the VCU 206 may share a power bus with the automotive computer 204 and may be configured and/or programmed to coordinate the data between vehicle 202 systems, connected servers (e.g., the server(s) 220), and other vehicles (not shown in FIG. 2) operating as part of a vehicle fleet. The VCU 206 may include or communicate with any combination of the ECUs 210, such as a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 206 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a Radio Detection and Ranging (“radar”) sensor configured for detection and localization of objects inside and outside the vehicle 202 using radio waves, sitting area buckle sensors, sitting area sensors, a Light Detecting and Ranging (“lidar”) sensor, door sensors, proximity sensors, temperature sensors, weight sensors, vehicle wheel sensors, vehicle internal or external cameras (configured to capture images of vehicle surroundings), vehicle external power usage sensors, etc. In some aspects, the vehicle external power usage sensors may be associated with the vehicle power system, and may detect an actual vehicle power system usage such as an actual amount of energy (current/power) that may be getting drawn from the vehicle power system, a time duration for which the energy may be drawn, a rate at which the energy may be drawn, etc.

In some aspects, the VCU 206 may control the vehicle 202 operational aspects and implement one or more instruction sets received from the user device 212, from one or more instruction sets stored in the memory 218, including instructions operational as part of the power management system 208.

The TCU 228 may be configured and/or programmed to provide vehicle connectivity to wireless computing systems onboard and off board the vehicle 202, and may include a Navigation (NAV) receiver 236 for receiving and processing a GPS signal, a BLE® Module (BLEM) 238, a Wi-Fi transceiver, a UWB transceiver, and/or other wireless transceivers (not shown in FIG. 2) that may be configurable for wireless communication (including cellular communication) between the vehicle 202 and other systems (e.g., the user device 212, a vehicle key fob, etc., not shown in FIG. 2), computers, and modules. The TCU 228 may be disposed in communication with the ECUs 210 by way of a bus.

The ECUs 210 may control aspects of vehicle operation and communication using inputs from human drivers, inputs from an autonomous vehicle controller, the power management system 208, and/or via wireless signal inputs received via the wireless connection(s) from other connected devices, such as the user device 212, the server(s) 220, among others.

The BCM 222 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, door locks and access control (including vehicle power system control), and various comfort controls. The BCM 222 may also operate as a gateway for bus and network interfaces to interact with remote ECUs (not shown in FIG. 2).

The DAT controller 230 may provide Level-1 through Level-3 automated driving and driver assistance functionality that can include, for example, active parking assistance, vehicle backup assistance, and/or adaptive cruise control, among other features. The DAT controller 230 may also provide aspects of user and environmental inputs usable for user authentication.

In some aspects, the automotive computer 204 may connect with an infotainment system 240 that may include a touchscreen interface portion, and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion, and/or display notifications, navigation maps, etc. on the touchscreen interface portion. The vehicle 202 may further include speakers/sound exciters (not shown) to provide notifications to the user.

The computing system architecture of the automotive computer 204, the VCU 206, and/or the power management system 208 may omit certain computing modules. It should be readily understood that the computing environment depicted in FIG. 2 is an example of a possible implementation according to the present disclosure, and thus, it should not be considered limiting or exclusive.

The vehicle 202 may further include a battery 242 configured to store power. The vehicle 202 may additionally include a vehicle power system (e.g., a power on-board (POB) 244, described above in conjunction with FIG. 1) that may transfer power from the battery 242 to the external accessory 110. In some aspects, the POB 244 may include an inverter and an electric motor (not shown) that may be powered by the battery 242. In further aspects, the POB 244 may include a circuit breaker that may stop the flow of current from the POB 244 when the POB 244 outputs current/power that is greater than a threshold value.

In accordance with some aspects, the power management system 208 may be integrated with and/or executed as part of the ECUs 210. The power management system 208, regardless of whether it is integrated with the automotive computer 204 or the ECUs 210, or whether it operates as an independent computing system in the vehicle 202, may include a transceiver 246, a processor 248, and a computer-readable memory 250.

The transceiver 246 may receive information/inputs from one or more external devices or systems, e.g., the user device 212, the server(s) 220, and/or the like via the network 214. For example, the transceiver 246 may receive a user request and/or user inputs/instructions to use/control the POB 244 (e.g., via the user device 212 wirelessly or via the infotainment system 240). Further, the transceiver 246 may transmit notifications (e.g., alert/alarm signals) or information to the external devices or systems such as the user device 212. In addition, the transceiver 246 may receive information/inputs from vehicle 202 components such as the infotainment system 240, the vehicle sensory system 234, and/or the like. Further, the transceiver 246 may transmit notifications (e.g., alert/alarm signals) to the vehicle 202 components such as the infotainment system 240.

The processor 248 and the memory 250 may be the same as or similar to the processor 216 and the memory 218, respectively. Specifically, the processor 248 may utilize the memory 250 to store programs in code and/or to store data for performing aspects in accordance with the disclosure. The memory 250 may be a non-transitory computer-readable memory storing the vehicle power management program code.

In some aspects, the memory 250 may further store details (that the vehicle 202 may obtain from the server 220) associated with power consumption rate and/or capacity (or expected power consumption rate) of different accessories that may be connected with the POB 244 to draw power. For instance, the memory 250 may store a first mapping of a plurality of types of external accessories (including the external accessory 110) and corresponding power ratings or current ratings. In addition, the memory 250 may store a second mapping of a plurality of types of external accessories and corresponding energy consumption profiles. The energy consumption profile may be a characterization of an expected energy consumption pattern over time. Furthermore, the memory 250 may store the POB 244 capacity (e.g., the POB's maximum power/current discharge capacity).

In operation, the processor 248 may obtain a user request to use/control the vehicle power system from the user device 212 or the infotainment system 240, via the transceiver 246. The user request may include a request to activate an outlet (such as the outlet 115) associated with the POB 244 to enable the vehicle 202 to supply energy to the external accessory 110. Responsive to obtaining the user request, the processor 248 may activate the outlet 115 based on the user request to provide the power to the external accessory 110.

In further aspects, the processor 248 may obtain real-time inputs from the vehicle sensory system 234, for example, when the POB 244 may be operational or providing power to the external accessory 110. In some aspects, the processor 248 may obtain the inputs from the vehicle sensory system 234 (such as the vehicle exterior cameras, the vehicle external power usage sensors, etc.) at a predetermined frequency via the transceiver 246. In further aspects, the processor 248 may obtain the inputs from the vehicle sensory system 234, for example, when the POB 244 may be activated based on the user request. The processor 248 may store and monitor the vehicle power system usage (i.e., the POB 244 usage) based on the real-time inputs obtained from the vehicle sensory system 234.

Responsive to obtaining the inputs from the vehicle sensory system 234, the processor 248 may determine/identify the type associated with the external accessory 110 that may be connected to the POB 244. Stated another way, the processor 248 may characterize the external accessory 110 that may be connected to the outlet 115 (or the external accessory 110 that the user may connect to the outlet 115). For instance, the processor 248 may identify whether the vehicle power system is attached/connected to a chop saw, an air compressor, an angle grinder, a jackhammer, a projector, loudspeakers, and/or the like.

In one exemplary aspect, to identify the external accessory type, the processor 248 may obtain a first input from the vehicle internal/external cameras, and may determine the external accessory type based on the first input obtained from the vehicle internal/external cameras (or the images captured by the vehicle internal/external cameras, via image recognition). The processor 248 may use Artificial Intelligence (AI) or Machine Learning (ML) based techniques or algorithms (that may be stored in the memory 250) to determine external accessory type based on the first input obtained from the vehicle internal/external cameras.

In another exemplary aspect, the external accessory 110 may include a radio frequency identification (RFID) tag that may indicate the external accessory type, and the vehicle 202 may include a RFID reader that may read the information from the RFID tag. In this case, the processor 248 may obtain a second input from the RFID reader and determine the external accessory type based on the second input.

In yet another exemplary aspect, to identify the external accessory type, the processor 248 may obtain a third input from the user device 212, which may indicate the external accessory type. In some cases, the third input may be a part of the user request that indicates the external accessory type. In this case, the processor 238 may determine the external accessory type based on the third input or the user request.

In yet another exemplary aspect, the processor 248 may obtain a fourth input from a wireless communication device that facilitates wireless communication between the vehicle 202 and the external accessory 110 and determine the external accessory type based on the fourth input. The wireless communication device may be, for example, a Bluetooth transceiver, a UWB transceiver, and/or the like that may be part of the external accessory 110. In further aspects, the processor 248 may use any other component/device to determine the external accessory type, including other forms of data entry/bar code scanning/user entered supplement information that indicates the external accessory type.

Responsive to determining the external accessory type, the processor 248 may determine an expected energy usage associated with the external accessory 110 based on the external accessory type. In some aspects, the processor 248 may determine an expected current/power that the external accessory 110 may draw from the POB 244 or determine current/power rating associated with the external accessory 110 to determine the expected energy usage. In some aspects, the processor 248 may obtain a pre-stored mapping of different external accessory types and corresponding expected energy usage information and determine the expected energy usage based on the pre-stored mapping.

Specifically, the processor 248 may obtain the first mapping and/or the second mapping from the memory 250 and/or the server 220. As described above, the first mapping may be a mapping of a plurality of types of external accessories (including the external accessory 110) and corresponding power ratings or current ratings. In addition, the second mapping may be a mapping of a plurality of types of external accessories and corresponding energy consumption profiles. The energy consumption profile may be a characterization of energy consumption pattern over time (e.g., how much the external accessory 110 may draw from the POB 244).

In some aspects, responsive to obtaining the first mapping, the processor 248 may correlate the external accessory type with the first mapping, determine the external accessory power/current rating based on the correlation. The processor 248 may then determine the expected energy usage associated with the external accessory 110 based on the determination of the external accessory power/current rating. Similarly, responsive to obtaining the second mapping, the processor 248 may correlate the external accessory type with the second mapping and determine the expected energy usage based on the correlation.

In some cases, the expected energy usage may change based on different conditions. For example, the expected energy usage may change based on ambient temperature (e.g., sun load), length of a cable that connects the outlet 115 and the external accessory 110, and/or the like. In such cases, the processor 248 may obtain the information associated with real-time weather conditions (e.g., from the server 220) and may determine the expected energy usage based on the real-time weather information. In some aspects, the processor 248 may obtain a third mapping from the memory 250 and/or the server 220. The third mapping may include a mapping of a plurality of types of external accessories and respective quantitative effects (e.g., in percentage) of weather conditions on their energy usage. For example, the third mapping may indicate that the expected energy usage of chop saw may change (e.g., increase) by 2% when the temperature is below a threshold value. The processor 248 may determine the expected energy usage based on the third mapping.

In some aspects, the processor 248 may correlate the expected energy usage determined by using the first/second mapping with the expected energy usage determined using the real-time weather information (or the third mapping) to determine a final expected energy usage associated with the external accessory 110. Similarly, the processor 248 may obtain cable information (e.g., cable length) associated with the cable that connects the external accessory 110 to the POB 244 and determine the expected energy usage based on the cable information. In some aspects, the processor 248 may obtain the cable information from vehicle sensors (e.g., vehicle cameras) or from the user 125 (e.g., via the user device 212, the infotainment system 240, etc.).

In further aspects, the processor 248 may determine actual energy usage associated with the POB 244. To determine the actual energy usage, the processor 248 may obtain information/inputs associated with real-time actual energy usage associated with the POB 244 from the vehicle external power usage sensors (that may be part of the vehicle sensory system 234), via the transceiver 246. As described above, the vehicle external power usage sensors may detect the actual energy usage such as an amount of energy (current/power) drawn, a time duration for which the energy may be drawn, and/or a rate at which the energy may be drawn, etc. In some aspects, the processor 248 may store the actual energy usage information (obtained from the vehicle sensory system 234) in the memory 250 (e.g., in a form of a lookup table), at a regular frequency or at predefined time intervals. In some aspects, the processor 248 may additionally or alternatively determine an actual energy usage associated with the external accessory 110 when the external accessory 110 may be connected to the POB 244. For instance, the processor 248 may determine the actual or real-time current/power that the external accessory 110 may be drawing from the POB 244 over a predetermined time duration. In some aspects, the processor 248 may determine the actual energy usage based on inputs obtained from an external accessory sensor associated with the external accessory 110, which detects the actual energy usage of the external accessory 110.

Responsive to determining the real-time actual energy usage (e.g., the actual energy usage of the vehicle power system or the external accessory 110) as described above, the processor 248 may correlate the expected energy usage and the actual energy usage, and perform one or more actions (e.g., remedial actions) based on the correlation. In an exemplary aspect, the processor 248 may compare the actual energy usage with the expected energy usage, and perform the actions based on the comparison. Specifically, the processor 248 may determine a difference between the actual energy usage and the expected energy usage and perform the action when the difference is greater than a threshold value. For example, the processor 248 may determine whether the current output from the POB 244 is greater than the external accessory current rating or whether the power output from the POB 244 is greater than the external accessory power rating. When the processor 248 determines that the output current/power is greater than the external accessory's current/power rating, the processor 248 may perform one or more remedial actions. Examples of remedial actions are described below, which should not be construed as limiting.

In some aspects, the action may include outputting a notification for the user 125. The processor 248 may output the notification via a vehicle speaker system (e.g., an exterior sound exciter), the user device 212, the infotainment system 240, and/or the like. In some aspects, the processor 248 may display the notification via a user interface in a graphical form (or any other form). The notification may indicate the actual energy drawn by the external accessory 110 (e.g., external accessory 110 current consumption) over a predefined time duration such as past 30 minutes, past 1 day, and/or the like, as shown in view 302 of FIG. 3.

In some aspects, the processor 248 may output a first notification to the user 125 when the actual energy usage may be greater or less than the expected energy usage. The first notification may indicate that the actual energy usage is greater or less than the expected energy usage. For instance, the processor 248 may output the first notification when the current output from the POB 244 may be greater than the external accessory current rating or if the power output from the POB 244 may be greater than the external accessory power rating.

In further aspects, the processor 248 may determine the reason(s) for the increase in the actual power usage. The reasons may include, for example, extreme or prolonged external accessory usage, presence of certain environmental conditions in which the external accessory 110 may be operating, suboptimal condition of the external accessory 110, and/or the like. Example ways in which the processor 248 may determine the reason are described below, which should not be construed as limiting.

In one exemplary aspect, to determine the reason, the processor 248 may correlate the actual energy usage associated with the POB 244 (or the external accessory 110) and the real-time weather information. In some aspects, the processor 248 may correlate the actual energy usage and the real-time weather information when the actual energy usage may be greater than the expected energy usage. Based on the correlation, the processor 248 may determine that the external accessory 110 may be drawing more than the expected current due to environmental conditions (e.g., ambient temperature, sun load etc.).

Responsive to determining the reason as being the environmental conditions as described above, the processor 248 may output a second notification for the user 125 that includes information associated with the reason described above and a recommendation of an optimal time of the day to power the external accessory 110 via the POB 244, at which the current draw may be expected to be less effected by the environmental conditions (e.g., due to sun load and/or temperature). In some aspects, the processor 248 may leverage the server 220 to determine/suggest the time of the day described above. For instance, the processor 248 may output a notification stating that “It is advisable to connect the external accessory at 5 PM”, as shown in view 304.

In another exemplary aspect, to identify the reason, the processor 248 may determine that the POB 244 may be connected to another external accessory (or supplying power to another external accessory in addition to the external accessory 110). Responsive to such determination, the processor 248 may determine the energy that the other external accessory may be drawing and correlate this information with the expected energy usage associated with the external accessory 110. Based on the correlation, the processor 248 may determine that the external accessory 110 and the other external accessory are not configured to be connected to the POB 244 at the same time (as the energy consumption of the external accessory 110 and the other external accessory may exceed a POB maximum energy limit). Responsive to such determination, the processor 248 may output a third notification that includes the determined reason described above (i.e., two external accessories may be connected to the POB 244 at the same time) and indicates that the external accessory 110 and the other external accessory should not be connected to the POB 244 at the same time. In the third notification, the processor 248 may request the user 125 to turn-on only external accessory at a time. For instance, the processor 248 may determine that chop saw and vacuum device are being operated at the same time via the POB 244. Responsive to such determination, the processor 248 may output a notification to the user 125 stating “Turn-off the saw or the vacuum device as both the devices cannot be operated simultaneously” as shown in view 306.

In some aspects, to effectively determine that two external accessories may be operating together via the POB 244, the processor 248 may first characterize different external accessories that may be connected to the POB 244 based on the current drawn by respective external accessories. Specifically, the processor 248 may use the second mapping and the actual current drawn information to characterize different external accessories. In addition, the processor 248 may characterize different external accessories based on the inputs obtained from the vehicle internal/external cameras, as described above. Based on the characterization of the different external accessories, the processor 248 may determine that two external accessories may be operating together via the POB 244.

In another exemplary aspect, to identify the reason, the processor 248 may determine that the external accessory 110 may be in a suboptimal condition or may have a low capacity based on the images captured by the vehicle interior/exterior cameras, comparison of the expected energy usage and actual energy usage, and/or the like. For example, the processor 248 may determine that the external accessory 110 may be drawing more than the expected current (or the expected energy usage), which may indicate that the external accessory 110 may be in a suboptimal condition or may have a low capacity. Based on such determination, the processor 248 may output a fourth notification for the user 125 that includes a recommendation to procure and connect a high-capacity external accessory (or connect a different external accessory with a higher power rating) to the POB 244 or repair the external accessory 110. In this manner, the processor 248 may predict accessory maintenance for the external accessory 110 based on the comparison of the expected energy usage and actual energy usage. The processor 248 may be further configured to transmit the prediction to the user device 212, or the server 220 so that the external accessory 110 may be repaired (if required). Specifically, the processor 248 may transmit the prediction when the actual accessory power consumption may be less (or greater) than a threshold value.

In addition to or instead of outputting the notifications described above for the user 125, the processor 248 may automatically control POB operation (as a part of the remedial action) based on the comparison of the expected and actual current/power values, as part of the remedial actions. For instance, the processor 248 may de-rate/reduce the current/power transferred from the POB 244 to the external accessory 110 (or limit the POB discharge rate), when the processor 248 determines that the current output from the POB 244 is greater than the external accessory current rating or when the power output from the POB 244 is greater than the external accessory power rating.

In addition, the processor 248 may limit the external accessory usage. For example, the processor 248 may deactivate the POB 244 when the external accessory 110 draws more than 5 KW power (or any other predefined power value) from the POB 244. In addition, when the processor 248 determines that two external accessories (e.g., the external accessory 110 and the other external accessory) are connected together to the POB 244 and they should not be connected together at the same time, the processor 248 may turn-off other circuits to enable the external accessory 110 to receive the power supply from the POB 244 and disable the other external accessory from receiving any power from the POB 244. In some aspects, the processor 248 may turn-off the other circuits responsive to obtaining a user approval to turn-off the other circuits. In some aspects, the processor 248 may proactively de-rate current/power from the POB 244 based on user preference that may be part of the user request to support longer duration higher current usage (i.e., by using less current/power in the first 10 mins, a higher average power may be continuously supported for the first 20 mins).

In further aspects, the processor 248 may obtain/fetch the actual energy usage information (real-time inputs for the actual energy usage) associated with the POB 244 from the memory 250 and may monitor the real-time inputs over a predefined time duration. Based on the monitoring, the processor 248 may check whether a predetermined condition is met. Responsive to determining that the predetermined condition is met, the processor 248 may perform the actions described above (e.g., the remedial actions such as outputting the notification to the user 125, automatically controlling the POB 244, etc.).

In some aspects, the predetermined condition may be met when the POB 244 supplies power to the external accessory 110 for a time duration greater than a predetermined time duration or when the external accessory 110 may be repeatedly connected to the POB 244 at a frequency greater than a predefined frequency threshold. For instance, the processor 248 may determine that the predetermined condition is met when the external accessory 110 draws power from the POB 244 for a prolonged time (e.g., more than 30 minutes). In such situations, the processor 248 may output a notification to the user 125 requesting the user 125 to turn-off the external accessory 110. Additionally or alternatively, in this case, the processor 248 may automatically stop the power supply from the POB 244 to the external accessory 110 to prevent excessive heating of the external accessory 110. In further aspects, the processor 248 may determine that the predetermined condition is met when the processor 248 observes a sudden increase in energy demand from the external accessory 110.

In further aspects, the processor 248 may automatically control a vehicle parameter to increase available POB power (as a part of the remedial action). The vehicle parameter may be associated with at least one of an engine speed, a vehicle climate temperature, a vehicle audio system, and/or the like. For instance, the processor 248 may shut-off the power supply to the vehicle audio system to increase the available POB power. In addition, the processor 248 may modify hybrid controls, modify vehicle settings, and/or the like.

In further aspects, the processor 248 may obtain inputs associated with real-time sound energy produced by the external accessory 110 when the external accessory 110 may be connected to the POB 244. In some aspects, the processor 248 may obtain such inputs from the microphones that may be installed in the vehicle 202. The microphones may capture sound that may be produced by the external accessory 110 when the external accessory 110 may be connected to the POB 244. In addition, the processor 248 may determine an expected sound energy produced by the external accessory 110 based on the external accessory type (similar to the determination of the expected energy usage). The processor 248 may compare the expected sound energy with the real-time sound energy produced by the external accessory, and perform the action (e.g., remedial action) based on the comparison. For instance, the processor 248 may output a notification to the user, in the same manner as described above, when the processor 248 determines that the external accessory 110 may be producing an unexpected sound (e.g., higher than expected).

In further aspects, the processor 248 may determine when it may not be possible to use alternating current (AC) and direct current (DC) at the same time and may perform the action described above based on such determination. For instance, the processor 248 may provide output a recommendation for the user 125 (via the user device 120 and/or the infotainment system 240) to switch between batteries and direct AC or DC plug-in connections (as a part of the remedial actions) when the external accessory 110 may be operated on its own batteries or plugged in to the POB 244. In addition, the processor 248 may suggest charging of batteries for the external accessory 110 (that may be capable of operating on batteries) to maximize the efficiency of operation, when the processor 248 determines that the external accessory 110 may not be in use. In addition, the processor 248 may stop the battery charging when the external accessory 110 may be directly plugged-in to the POB 244, when the processor 248 determines that external accessory 110 batteries are being charged and detects the external accessory 110 usage via the POB 244.

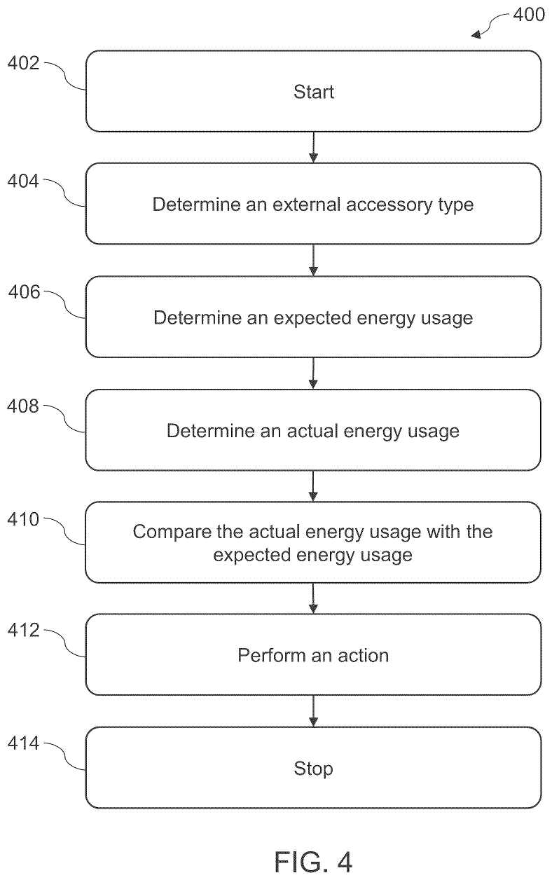

FIG. 4 depicts a flow diagram of an example method 400 to manage energy usage of the vehicle power system in accordance with the present disclosure. FIG. 4 may be described with continued reference to prior figures, including FIGS. 1-3. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include determining, by the processor 248, the type of the external accessory 110 connected to the vehicle power system (or the POB 244). The vehicle power system may transfer power from the battery 242 to the external accessory 110 connected to the vehicle power system.

At step 406, the method 400 may include determining, by the processor 248, an expected energy usage associated with the external accessory 110 based on the external accessory type. At step 408, the method 400 may include determining, by the processor 248, the actual energy usage associated with the vehicle power system or the external accessory 110 based on inputs obtained from the vehicle sensor (e.g., the vehicle power usage sensors) or external accessory sensor(s). The vehicle sensor may detect the actual energy usage associated with the vehicle power system, and/or the external accessory sensor may detect the actual energy usage associated with the external accessory 110. At step 410, the method 400 may include comparing, by the processor 248, the actual energy usage with the expected energy usage. At step 412, the method 400 may include performing, by the processor 248, one or more actions (e.g., remedial actions) based on the comparison, as described above.

The method 400 may end at step 414.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A vehicle comprising:
a battery;
a vehicle power system configured to transfer power from the battery to an external accessory connected to the vehicle power system;
a vehicle sensor configured to detect an actual energy usage of the vehicle power system; and
a processor configured to:
determine a type of the external accessory connected to the vehicle power system;
determine an expected energy usage associated with the external accessory based on the type;
determine the actual energy usage of the vehicle power system or an actual energy usage of the external accessory based on inputs obtained from the vehicle sensor or an external accessory sensor, wherein the external accessory sensor is configured to detect the actual energy usage of the external accessory;
compare the actual energy usage with the expected energy usage; and
perform an action based on comparing the actual energy usage with the expected energy usage.

2. The vehicle of claim 1 further comprising a vehicle camera configured to capture images of vehicle surroundings, wherein the processor is further configured to:
obtain a first input from the vehicle camera; and
determine the type based on the first input.

3. The vehicle of claim 1, wherein the processor is further configured to:
obtain a second input from a wireless communication device that facilitates wireless communication between the vehicle and the external accessory; and
determine the type based on the second input.

4. The vehicle of claim 1, wherein the processor is further configured to:
obtain a third input from a user device; and
determine the type based on the third input.

5. The vehicle of claim 1, wherein the processor is further configured to:
determine a power rating or a current rating of the external accessory based on the type; and
determine the expected energy usage based on the power rating or the current rating.

6. The vehicle of claim 5, wherein the processor is further configured to:
obtain a first mapping of a plurality of types of external accessories and corresponding power ratings or current ratings responsive to the determination of the type;
correlate the type with the first mapping; and
determine the power rating or the current rating of the external accessory based on the correlation.

7. The vehicle of claim 1, wherein the processor is further configured to:
obtain a second mapping of a plurality of types of external accessories and corresponding energy consumption profiles, wherein an energy consumption profile is a characterization of an energy consumption pattern over time;
correlate the type with the second mapping; and
determine the expected energy usage based on the correlation.

8. The vehicle of claim 1, wherein the processor is further configured to:
obtain real-time weather information; and
determine the expected energy usage based on the real-time weather information.

9. The vehicle of claim 1, wherein the processor is further configured to:
obtain cable information associated with a cable that connects the external accessory to the vehicle power system; and
determine the expected energy usage based on the cable information.

10. The vehicle of claim 1, wherein, to perform the action, the processor outputs a first notification, and wherein the first notification indicates that the actual energy usage is greater or less than the expected energy usage.

11. The vehicle of claim 1, wherein, to perform the action, the processor outputs a second notification, and wherein the second notification comprises a recommendation to connect a different external accessory with a higher power rating or repair the external accessory.

12. The vehicle of claim 1, wherein, to perform the action, the processor outputs a third notification, and wherein the third notification comprises a recommendation of a time of a day to power the external accessory via the vehicle power system.

13. The vehicle of claim 1, wherein, to perform the action, the processor:
determines that the vehicle power system is supplying power to a second external accessory;
determines that the external accessory and the second external accessory are not configured to be connected to the vehicle power system at a same time; and
outputs a fourth notification responsive to a determination that the external accessory and the second external accessory are not configured to be connected to the vehicle power system at the same time, wherein the fourth notification indicates that the external accessory and the second external accessory cannot be connected to the vehicle power system at the same time.

14. The vehicle of claim 1, wherein, to perform the action, the processor adjusts a vehicle power system operation.

15. The vehicle of claim 1, wherein, to perform the action, the processor controls a vehicle parameter to increase an available power for the vehicle power system.

16. The vehicle of claim 15, wherein the vehicle parameter is associated with at least one of:
an engine speed, a vehicle climate temperature, or a vehicle audio system.

17. The vehicle of claim 1, wherein the processor is further configured to:
store real-time inputs from the vehicle sensor in a memory;
monitor the real-time inputs over a predefined time duration;
determine that a predetermined condition is met based on the monitoring, wherein the predetermined condition is met when the vehicle power system supplies power to the external accessory for a time greater than a predetermined time duration or when the external accessory is repeatedly connected to the vehicle power system at a frequency greater than a predefined frequency threshold; and
perform the action when the predetermined condition is met.

18. The vehicle of claim 1, wherein the processor is further configured to:
obtain inputs associated with real-time sound energy produced by the external accessory when the external accessory is connected to the vehicle power system;
determine an expected sound energy produced by the external accessory based on the type;
compare the expected sound energy with the real-time sound energy produced by the external accessory; and
perform the action based on comparing the expected sound energy with the real-time sound energy produced by the external accessory.

19. A method comprising:
determining, by a processor, a type of an external accessory connected to a vehicle power system, wherein the vehicle power system is configured to transfer power from a vehicle battery to the external accessory connected to the vehicle power system;
determining, by the processor, an expected energy usage associated with the external accessory based on the type;
determining, by the processor, an actual energy usage of the vehicle power system or the external accessory based on inputs obtained from a vehicle sensor or an external accessory sensor, wherein the vehicle sensor is configured to detect the actual energy usage of the vehicle power system, and wherein the external accessory sensor is configured to detect the actual energy usage of the external accessory;
comparing, by the processor, the actual energy usage with the expected energy usage; and
performing, by the processor, an action based on comparing the actual energy usage with the expected energy usage.

20. A non-transitory computer-readable storage medium having instructions stored thereupon which, when executed by a processor, cause the processor to:
determine a type of an external accessory connected to a vehicle power system, wherein the vehicle power system is configured to transfer power from a vehicle battery to the external accessory connected to the vehicle power system;
determine an expected energy usage associated with the external accessory based on the type;
determine an actual energy usage of the vehicle power system or the external accessory based on inputs obtained from a vehicle sensor or an external accessory sensor, wherein the vehicle sensor is configured to detect the actual energy usage of the vehicle power system, and wherein the external accessory sensor is configured to detect the actual energy usage of the external accessory;
compare the actual energy usage with the expected energy usage; and
perform an action based on comparing the actual energy usage with the expected energy usage.
